(19) United States
(12) Patent Application Publication
(10) Pub. No.: US 2005/0235199 A1
(43) Pub. Date: Oct. 20, 2005

(54) Method and system for checking content before dissemination

(76) Inventor: Wesley Adams, Los Angeles, CA (US)

Correspondence Address: Micah R. Onixt;DLA Piper Rudnick Gray Cary US LLP, P.O. Box 64807, Chicago, IL, 60664-0807, US

(21) Appl. No.: 11/146,808

(22) Filed: Jun. 7, 2005

Related U.S. Application Data
(62) Division of application No. 10/081,762, filed on Feb. 19, 2002.

(51) Int. Cl. H04K 1/00

(52) U.S. Cl. 715/512

(57) ABSTRACT

A content checking system for evaluating content sponsored by a content sponsor and intended to be checked by a content disseminator or third-party before the content is disseminated is described. The system allows a content sponsor to submit content in an electronic form to a content checking service provider and have the content distributed to various recipients which may also be the content disseminators. Feedback is collected by the recipients and transmitted back to the submitter via the service provider. The content is distributed in an efficient manner, typically over a computer network, such as the Internet, and feedback on the content is collected, formatted in a manner that is appropriate for the submitter, and transmitted to the submitter via the service provider. In a preferred embodiment, the content checking system is used for clearance of commercials or any type of content intended to be exhibited on television. The content sponsor is an advertiser who may produce the commercial itself or have an agency produce the commercial. The commercial is sent to a content disseminator such as a television broadcaster (e.g., ABC, Fox, NBC, etc.). The clearance department at the broadcaster collects comments on the commercials and sends the feedback back to the advertiser via the clearance service provider.

### FIELD OF THE INVENTION

The present invention relates to methods and systems for checking, obtaining comments on and approving content before the content is disseminated while maintaining the integrity of the content. In particular, it relates to methods of coordinating a checking process for content stored on a medium before the content is disseminated. In a preferred embodiment, the methods and systems are used in a clearing context where content must be approved before broadcasted to the public.

### BACKGROUND OF THE INVENTION

In many organizations, content must be checked and approved for distributing by multiple, often geographically distant parties before it leaves the confines of the organization. The term check is used in its broadest sense and can take many forms, such as reviewing, editing, commenting or evaluating, depending on the context in which it is used. The requirement that content be checked before being disseminated may be self-imposed or may be based on laws, regulations, and rules. The type of content can vary widely. Examples include music, written text, computer programs, video, graphics and the numerous combinations and variations of each of these. Given the breadth and complexity of many organizations and industries today that have reasons for checking content, the procedures presently in place have grown inefficient and error-prone. The logistics involved in distributing the content internally, for example within a company or among entities in a particular industry, during the checking process are often uncoordinated, expensive and time-consuming. Content may be distributed from one source to numerous destinations, via fax, messenger, mail, online, and so on, and is then returned to the originating parties or to other parties. Each of these persons may have some type of input regarding the content which must be collected and evaluated by either the originating individual or some other party. Of course, there are numerous variations on this procedure, which is but one example. In other scenarios the content may have numerous discrete content items where each item must be checked separately. Furthermore, different individuals may be responsible for checking the different content items even though the content items are contained on one content medium such as one digital tape or one CD.

One context in which content checking is critical and has become increasingly complex and inefficient is the television industry. In the television industry the process of checking content before it is aired is known as clearance. It is also referred to more specifically as network clearance. For example, all commercials on television, referred to as “spots”, must be cleared by each broadcaster before the commercial is exhibited on television. The clearance procedure for spots normally involves at least three classes of entities: an advertiser, an advertising agency, and the broadcasters. In addition, other parties (such as trade groups) may also be included in the clearing process. Typically, an advertiser engages an advertising agency to create a commercial for one of the advertiser's products, such as a motion picture or a soft drink. The agency, directly or using the services of outside producers and directors creates a spot (or in some cases a series of spots referred to as a “campaign”) and stores the spot on a digital tape, the preferred medium for storing content during the clearance process. At the same time the spot is stored on the tape, the agency produces a memo that describes the content of the tape. The tape and memo are then sent to the advertiser to ensure that it meets the advertiser's expectations. Both items are also sent to the television broadcasters. The tape and memo are sent typically via messenger or express delivery, such as FedEx or Express Mail. Sometimes the memo is faxed and the tape is sent separately. In other instances the content on the tape is sent electronically through a high-speed network.

Once the broadcaster receives the tape and memo, the items are sent to the broadcaster's clearance department. An individual in the clearance department typically stamps the memo with an Approvals and Restrictions form and begins evaluating the spots, which may involve sending the tape and memo to other individuals within the broadcasting company. It may also involve sending the tape to an external third-party for approval. Furthermore, the tape is duplicated so that multiple copies can be sent to the various parties. When this is done, it is critical to keep track of who receives the tape and ensure that the content is not distributed to unauthorized individuals or to the public. The tape may contain numerous spots each of which must be evaluated separately. In any case, numerous faxes, phone calls, e-mails, hand deliveries, and so on occur during this process. Comments, notes, and any other feedback must be collected by the original recipient at the clearance department and then transmitted back to the advertising agency. Any required changes must be made to the spots and the clearance process starts over. As a result of the unsophisticated means with which the tape and memo are distributed to the necessary individuals and the varying amount of time in which feedback is received and assimilated, the clearance turn-around time for a single spot has become significantly long.

As noted earlier, the inefficient and complex logistics of content checking can be found in numerous contexts besides network clearance, i.e., clearance from broadcasters. For example, in the government context, a draft of a bill or regulation may have to be checked by numerous parties before it is available to the public. The draft may have numerous sections that need to be checked by an equal number of different entities or individuals. In another example, in the music industry a sound recording may have to be checked by numerous departments before it is shipped to retail stores. The engineering department may have to check it for sound quality, the artist may have to do a final check on the content, management may have to authorize its release, an external rating association may have to check it (e.g., for parental advisory warnings) and so on. In another context music videos may have to be cleared before being broadcasted. There are numerous other contexts such as in law firms where documents must be checked before leaving the firm, publishing houses where publishers check written text before disseminating the text to the public and many others. Documents relating to offererings of securities similarly require approvals by multiple sets of accountants, underwriters, self-regulatory organizations, experts and governmental agencies. In any case, the same or similar issues described in the clearance scenario arise in other context where content checking procedures may be necessary.

### SUMMARY OF THE PREFERRED EMBODIMENTS

Methods and systems for checking content before disseminating the content are described. An entity sponsoring content must, for one or more reasons, have its content checked, evaluated, reviewed, edited, approved, or cleared by internal and external parties before the content is released to its intended audience. An individual at the content sponsor, known as the submitter, submits the content along with other information to a clearance service provider via a computer network, such as the Internet. The service provider forwards the content to content disseminators who also perform their own content checking. The service provider may also forward the content to content checkers who are not content disseminators. In either case, feedback on the content is gathered and sent back to the clearance service provider. The service provider then sends the feedback to the submitter who then makes appropriate changes to the content if necessary. The content checkers may also enter comments or make requested or suggested edits in the content directly before sending the content back to the clearance service provider.

In one aspect of the invention, a method of checking content is described. Content is either created in an electronic form or is converted to electronic form. In either case, an electronic content file and an associated identifier are created on a first computer system. The electronic content file and the identifier are stored in a content medium on the first computer system. A submission form available from a content checking service provider is completed by the entity creating the electronic content file on the first computer system. The submission form describes the content medium and indicates one or more recipients of the content medium. The content medium and the submission form are transmitted by the service provider to one or more recipients. A recipient collects feedback data on the electronic file content stored in the content medium. The feedback data is then transmitted to the submitter via the content checking service provider.

In another aspect of the present invention, a method of checking content is described. An electronic package is received at a computer system belonging to an entity responsible for checking content before the content is disseminated. The electronic package is sent from a submitter and contains at least one content item. The content item is viewed by the entity and one or more comments are entered by the entity regarding the content item. The entity may also collect additional comments from one or more other entities assisting in the content checking process. The entity originally receiving the comments then transmits the comments to the submitter.

In another aspect of the present invention, a method of performing clearance in the television broadcasting context is described. A spot is encoded thereby creating an electronic spot file on a first computer system. An identifier is assigned to the electronic spot file. The file and identifier are associated with a content medium. A spot count is entered in a submission form corresponding to the content medium. The spot count corresponds to the number of electronic spot files associated with the content medium. Also entered is a list of one or more recipients of the content medium. In the clearance context a recipient may be a television network broadcaster and the party submitting the spots may be an advertiser. The recipients evaluate the electronic spot file stored in the content medium on a second computer system. Feedback relating to the electronic spot file is then transmitted to the party submitting the spots via the services of a clearance service provider.

In another aspect of the present invention, a computer system for checking content is described. A computer system having one or more processors and one or more memory storage areas is capable of implementing a content checking procedure. The memory storage area contains a conversion program for converting content, intended for dissemination, into an electronic content file. Also contained in the memory storage area is a submission form used by a submitter when submitting content to one or more content checkers. A distribution program is used for distributing the electronic content file and the submitter form to one or more content checkers. In some cases, the content checkers may also be the content disseminators. The computer system contains an access program for accessing the electronic content file and enabling the attachment of a comment to the electronic content file. The comment is then transmitted back to the submitter via the computer system.

### BRIEF DESCRIPTION OF THE DRAWINGS

FIG. 1 is a diagram showing the entities involved in one clearance scenario and a clearance system in accordance with one embodiment of the present invention.

FIGS. 2A, 2B, and 2C are flow diagrams of a clearance process in accordance with one embodiment of the present invention.

### DETAILED DESCRIPTION OF THE PREFERRED EMBODIMENTS

A content checking system in which a party creating a particular type of content must have the content checked by other parties before the content can be disseminated is described in the various figures. The content checking system enables a party creating content to transmit the content to multiple parties who will do the checking and obtain feedback from those parties in an efficient and streamlined manner. The content to be checked can be one or a combination of various forms. Examples include text, music, graphics, video, multimedia, and computer software, among others. The party creating the content can vary widely as well. Examples include an individual, a company, an organization, a trade association, a government agency, an educational institution, a public service institution, a publishing house, a sound recording company, a movie studio, a television studio, a video producer, and soon.

As such, the content checking system can be used in a variety of contexts. For example, in the government context, a draft of a bill or regulation may have to be checked by numerous individuals in various departments before it is made available to the public for comment. The draft may have numerous sections and sub-sections that need to be proofed by various entities and individuals. Another context where content needs to be checked before being disseminated is in the music industry. A sound recording may have to be checked by numerous departments before it is shipped to retail stores. For example, the engineering department may have to check it for sound quality, the artist may have to do a final check on the content, management may have to authorize its release, an external ratings association may have to approve it, and so on. Another context in which there is rigorous content checking is in the science and technical journal field. In this context, a draft of an article must go through several checks, such as peer reviews, editorial reviews, fact checking, and so on before it can be published. There are numerous other contexts such as in law firms where documents are checked before leaving the firm, publishers checking written text before disseminating the text to the public and many others contexts. In many of these contexts, the term used for checking may vary. For example, the terms authorize, approve, clear, verify, edit, evaluate, among others, may be used in a particular context. In any case, the content must be presented to at least one party for some type of content approval. In other cases, the content is sent to multiple parties from one sender for checking. In yet other cases, the multiple parties may send the content to further parties for checking. For example, a university professor performing a peer review of an article may pass the article to a post-doctoral student for a preliminary review. In all these cases, the comments (including “no comment”) provided by the checkers must be collected, and in some cases assimilated, by a central entity, such as the individual who initially received the content. In some cases where the content creator sends the content to numerous checkers, any one of these checkers who sends the content out to other ‘secondary’ checkers would be considered a central entity. In any case, the comments must make their way back to the content creator or other entity seeking the comments; the content creator itself may not be seeking the comment, but instead a party acting on behalf of the content creator may be doing so. Furthermore, the duplication of the content must be monitored and all copies of the content made during the content checking process should be tracked and deleted or otherwise destroyed once the checking process is complete to avoid distribution of inaccurate copies.

The content checking system and method can be implemented on a computer, electronic, telephone, wireless or digital network. The checking system significantly reduces the need for conventional modes of delivery of the content and related materials, such as some type of “approval/rejection” sheet or comment sheet. For example, the content and related materials need not be mailed, faxed, or hand-delivered among checking entities and the content creator. In cases where the content can be converted to some type of electronic form, such a conversion is performed so that the content can be transmitted over one of the networks identified above and the need for conventional delivery modes is nearly eliminated.

In a preferred embodiment, the content checking system is a distributed system. A distributed system is one that has components installed at different locations and where the components work in conjunction with each other to implement the system. A location is a computer memory storage area and CPU. Thus, it is possible that there are numerous locations in the same physical room, or numerous locations within the same computer network, or locations in different physical places and connected to each other via a public computer network, such as the Internet. In other cases the different locations may be connected by a computer network only accessible by certain types of entities, such as educational institutions, government bodies, consortiums of public companies, companies in a particular industry, and so on.

One industry in which content checking plays a critical role is in the television industry. In this industry, the act of checking is known as network clearance, or simply, clearance. The content is referred to as a “spot”. A spot is most typically an advertisement for a product or service. For example, a spot can advertise the availability and desirability of a consumer product, a service, a movie, a network show, or a public service message. All spots must be cleared by multiple sources before being exhibited on television. This includes network television, public access television, cable, and any other type of television exhibition. Before a spot can be exhibited it must be assigned a particular type of code, referred to as an ISCI code. Only spots with ISCI codes are entered into television network systems that control the actual broadcasting of content. The network clearance process must be completed before a spot is given an ISCI code.

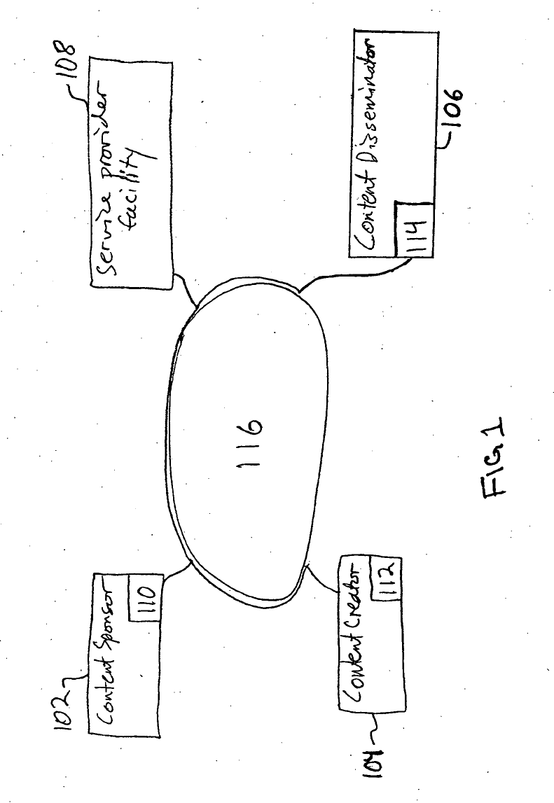

In a preferred embodiment, the content checking system is utilized to perform television clearance. In one context, television clearance involves three primary entities. FIG. 1 is a diagram showing the entities involved in one television clearance scenario and a television clearance system in accordance with one embodiment of the present invention. A content sponsor 102 is the entity that wants a spot to be aired. In a preferred embodiment, sponsor 102 is the advertiser. A content creator 104 is an entity that creates or produces the spot. One example of a content creator is an advertising agency. In some cases, content creator 104 creates a series of spots for content sponsor 102, referred to as a campaign. Content sponsor 102 instructs content creator 104 to create the spot for the good or service being advertised. A content disseminator 106 is an entity that broadcasts the spot. In a preferred embodiment, content disseminator 106 is a television network capable of broadcasting the spot. There may be numerous content disseminators in the case where content sponsor 102 wants to broadcast its spot on numerous television networks or stations, e.g., NBC, Fox, ABC and so on. The entities communicate over a network 116. In a preferred embodiment, network 116 is a global public network such as the Internet. In other preferred embodiments, network 116 is an electronic, telephone, or wireless network. In any case, network 116 should allow for digital transmission of data, preferably over a high-bandwidth network.

As noted above, an advertiser is any type of entity desiring to promote a message, service, or product. For example, an advertiser can be a movie studio and the product being promoted a feature film. The spot the movie studio wants to air is a trailer for the upcoming movie. The movie studio may go to an advertising agency to create the trailer. In another preferred embodiment, content sponsor 102 may create the spot itself and may not need a separate content creator 104. In the case of a movie studio, the spot may likely be created by the studio. In the case of a soft drink, content sponsor 102 would likely go to content creator 104 to commission a spot for its soft drink.

Once the spot is created, it is sent to content disseminator 106. In a preferred embodiment, it is sent to a clearance individual at a television broadcaster. The television broadcaster is said to own the signal used to broadcast the content. Most major broadcasters have a network clearance department with individuals responsible for clearing various types of spots, known as reviewers. All spots that are trailers for movies may go to a particular reviewer. A spot is ready for the network clearance process once the spot is in a “final” version. A final version of a spot is not necessarily the version that will be broadcasted, although it could be if it is approved without the need for any modifications. The version of the spot is “final” in that the clearance department may have received rough cuts, scripts, story boards, etc. of the spot from content creator 104 for a preliminary evaluation to avoid any obvious grounds of rejection before production of the spot. After this preliminary check is performed, which may not be requested in all cases, the network clearance department at a broadcaster receives a “final” version which is then formally put through the clearance process.

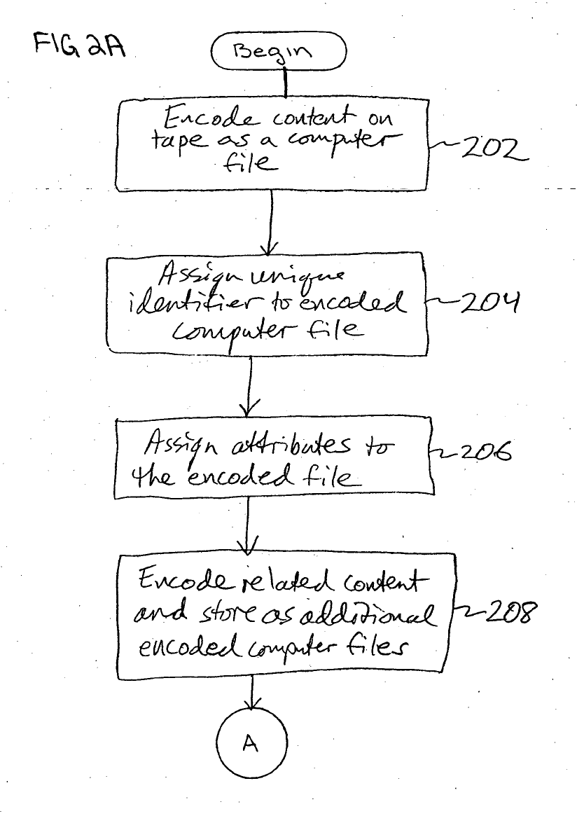

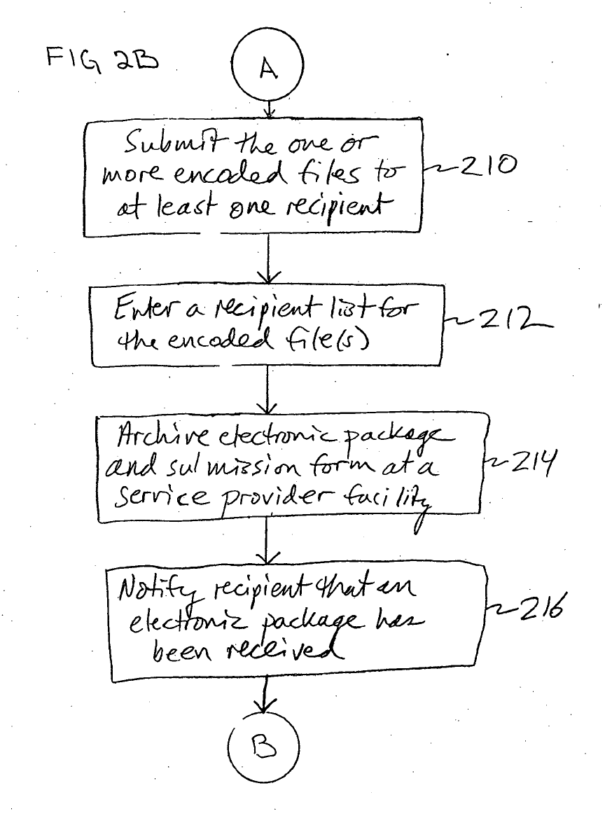

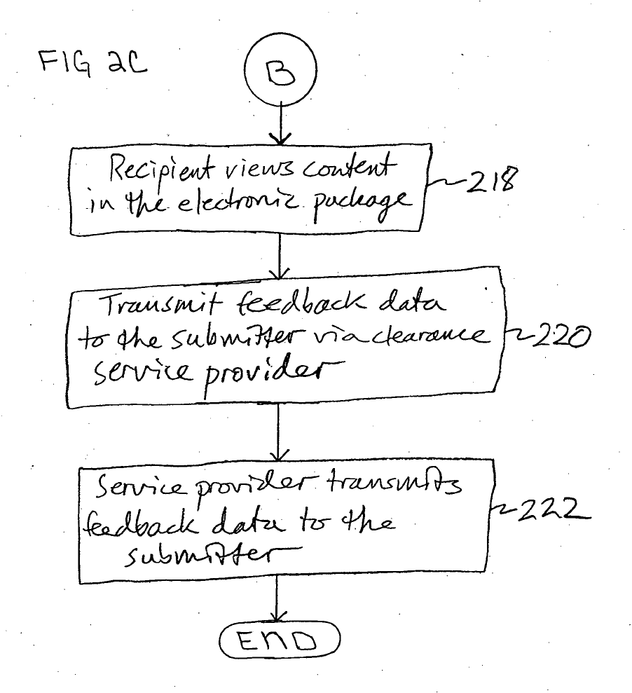

In a preferred embodiment, each of the entities described has a software component necessary to implement the content checking system. The components are identified in FIG. 1. Each of the components communicates with a service provider facility 108. A method of clearance implementing these components and the service provider facility is described in FIGS. 2A-2C below. In a preferred embodiment, content sponsor 102 uses a file encoder software component 110 to encode the spot and prepare a file name for the spot. When the spot is created by content creator 104, such as an advertising agency, it is provided with a software module 112 able to communicate with module 110 and facility 108. In a preferred embodiment, content disseminator 106 has a clearance software module 114 that communicates with service provider facility 108. One of the functions of module 114 is receiving the encoded spots and related information and distributing the data to the appropriate recipient(s) at the broadcaster clearance department. Other functions include terminal installation, server and LAN installation, and external connectivity. In a preferred embodiment, module 114 is also used for internal reviewer authentication, management of submissions from advertisers, and other functions.

FIGS. 2A, 2B and 2C are flow diagrams of a clearance process in accordance with one embodiment of the present invention. In the television industry a spot is created and stored in digital form. Specifically, it is stored on a D2 digital tape. This has been the practice for many years. Multiple related spots typically are placed on the same tape. For example, five different trailers, possibly varying in length and content, for the same movie are stored on one tape. The one or more spots are stored on the tape and given to the content sponsor, for example, a movie studio. In some cases, the content sponsor may have created the spots and thus already has possession of the tape.

At step 202 the content sponsor encodes a spot on the tape as a computer file. This is done at an encoding station. Most personal computers, workstations, and other computers can operate as an encoding station. Encoding is performed using any commercially available codec program. In a preferred embodiment a QuickTime file is created, specifically using QuickTime Version 5 or above. QuickTime is able to run any type of codec encoded file. As described below, the recipient of a QuickTime file can use third-party QuickTime navigation tools to view the file at the appropriate time. The encoded file is stored in a memory storage area on the encoding station. In a typical case, the file is stored on the encoding station hard drive and may be placed on the desktop of the computer performing as the encoding station.

At step 204 the encoded file is assigned a unique identifier. In a preferred embodiment, the identifier is automatically generated by the encoding station once the spot is encoded. The encoding is performed by a submitter, the individual at the advertiser who submits the spot to the broadcaster. In another preferred embodiment, the identifier is assigned by the individual encoding the spot. In another preferred embodiment, an ISCI code is assigned to the encoded file and is used as the unique identifier. At step 206 attributes are assigned to the encoded file by the submitter. The attributes describe the contents of the spot, e.g., 15-second spot, one month prior to movie release. There are also other attributes that can be attached to the encoded file describing the contents. In a preferred embodiment, there is a library of attributes in file encoder software module residing on the encoder station from which the submitter can select.

At step 208 the submitter is asked whether there are other spots that need to be encoded that should be submitted with the spots already encoded; that is, are there other related spots. For example, five different trailers for the same movie would be submitted to the broadcaster together. If there are other spots, control returns to step 202 and the process is repeated for each spot. Thus, after step 208 there is at least one spot that has been encoded and thus at least one encoded file. In some cases there is a collection of spots that contains related spots and is submitted to the broadcaster as a collection, as described below.

At step 210 the submitter submits the one or more encoded files and attribute data to at least one broadcaster. In a preferred embodiment the submitter, i.e., an individual at the content sponsor, accesses a network site created and maintained by a clearance service provider. One example is a clearance service provider web site on the Internet. Referring to FIG. 1, the web site is maintained at service provider facility 108. The submitter logs on to the web site and opens a submitter's form. In a preferred embodiment, some of the submitter's information, such as name, content sponsor, address, and other information is automatically filled into the form. This is possible since the web site identifies the computer and the information associated with the computer logging on and requesting the form, and because the content sponsor has a profile with the clearance service provider. This profile was provided to the service provider when the content sponsor obtained the file encoding software module; that is, when it became a customer of the service provider.

The submitter enters other information in to the form. Namely, the submitter indicates the number of spots being submitted to the broadcaster. This is referred to as a spot count. The identifier and the attributes of each spot are also provided. Conventionally, a group of related spots is placed on one D2 digital tape. The tape and one submission form for the tape are submitted to the broadcaster using conventional delivery means. In a preferred embodiment of the network clearance system, related spots that would normally be stored on one tape are grouped together and associated with one submission form. The group of related encoded files can be described as a “virtual” tape. The virtual tape is submitted electronically, such as in digital form over a computer network. The spot count, described above, is the number of encoded files, i.e., spots, on a virtual tape. The virtual tape is a content medium that is used to package one or more related spots. A spot is described more generally as a content item, such as a draft of an article to be published or a single music track on a multi-track CD. Numerous other examples of a content item and of content medium can be drawn from scenarios besides clearance in which content checking is needed as described herein.

Once all the information regarding the encoded files is entered into the submission form, at step 212 the submitter enters a recipient list. A recipient list is a list of entities, such as television broadcasting companies, which the content sponsor is requesting broadcast the one or more spots. If the content sponsor, such as the movie studio, only wants one broadcaster, such as Fox, to broadcast the spots, the sponsor will send the encoded files and submission form only to the clearance department at Fox. Other types of entities can also be indicated, such as an advertising agency (as a “cc:”), an independent clearing entity, and so on. This recipient list may also be referred to as a play list. By completing a recipient list, the clearance service provider will know where to send the encoded files and submission form. Since the distribution is done electronically, namely, through digital media, duplication houses, entities that physically duplicate D2 tapes for distribution to parties on a play list, are no longer needed. The virtual tape is submitted with the online submission form to the broadcaster. The submission form and the content medium, e.g., the virtual tape, are combined into an electronic package by the clearance service provider.

In a preferred embodiment, the submitter enters the recipient list and other pertinent or required information into the submission form and submits the form from the clearance provider web site. In another preferred embodiment, the submission form is downloaded to the submitter's encoding station, also referred to as the first computer system. At this stage copies of the encoded files are taken from the submitter's encoding station, e.g., the computer hard drive, and transmitted to the parties on the recipient list in the form of an electronic package. An electronic package consists of the encoded files combined with the submission form. In a preferred embodiment, each party on the recipient list must have the clearance service provider software installed, as described below. In a preferred embodiment, the files are transmitted to the recipients over the Internet using secure File Transfer Protocol (FTP). In another preferred embodiment, transmission of the files is done over another type of network, such as a virtual private network (VPN) or any other suitable computer network, using a secure transmission means. In a preferred embodiment, the appropriate server at the recipient site polls a server at the clearance service provider computer facility to check whether there is an electronic package for the recipient. That is, the service provider does not automatically send the electronic package to the recipient, such as a broadcaster. This is done primarily for security reasons and is one way to have content delivered to the recipient. If the recipient checks to see if it has anything waiting for it at the service provider computer facility, firewalls and other security measures at the recipient site are not compromised. The frequency with which the recipient computer system polls the clearance service site can be decided between the submitter and the broadcaster. In another preferred embodiment, if the broadcaster prefers, the electronic package, i.e., the encoded files and submission form, can be transmitted directly to the broadcaster once it arrives at the service provider computer facility.

At step 214 the encoded files in the electronic package and information in the submission form are archived at the clearance service provider facility before the package is sent to the recipients. In a preferred embodiment, the encoded files and form are cached in a memory storage area at the facility for rapid retrieval if necessary and stored in persistent or other long-term memory at a later time. In any case, the electronic package is sent to the recipients without delay. In a preferred embodiment, when sending the electronic package over the Internet, the package is received by a recipient at the speed at which the recipient receives Internet e-mail messages. Thus, the submitter sends the electronic package from a first computer system and the recipient receives the electronic package at a second computer system. The submission form is completed by the submitter at a clearance service provider web site operated from a service provider computer system.

At step 216 the recipient at the content disseminator is notified that an electronic package has been received in the recipient's e-mail “inbox” from a content sponsor via a clearance service provider. Along with the notification, the recipient receives the actual electronic package as an e-mail message. Following the same example as above, a reviewer in the network clearance department at a broadcaster receives the e-mail. In a preferred embodiment, the recipient opens the e-mail and a list of spots appears. In addition, all the data the recipient would normally see, most of which is from the submission form can be viewed. The data the recipient views regarding the spots can be referred to as a clearance memo. At step 218 the recipient clicks on a spot entry on the list and by doing so initiates a load media step. The load media step allows the recipient to view the content item. In a preferred embodiment, a reviewer is able to view the spot on the reviewer's computer system. On the screen while viewing the spot the reviewer can enter comments on that particular spot. The form in which the reviewer enters information is a feedback form. In a preferred embodiment, the feedback form is an “Approval and Restriction” form which the reviewer uses to either approve the spot or enter restrictions such as limitations when a spot can be aired. On the second computer system, the reviewer enters comments in the Approval and Restriction form and is able to forward the spot and the feedback form to another party if necessary. For example, the reviewer can forward the spot and the feedback form to a lead reviewer in the clearance department. In a preferred embodiment, if the recipient is not available, the electronic package is sent to a back-up recipient who is qualified to evaluate the spots. Reviewers in a clearance department are allowed to reissue an electronic package to themselves or others. It has been determined that the risk of others looking at a spot not intended for their review is not as critical as creating a slow-down in the approval time or business workflow. Records of the reviewer making the final approval of a spot will be maintained. In any case, comments are entered into the Approval and Restriction form by the appropriate parties and collected at the second computer system.

At step 220 the reviewer transmits the feedback form, in the example, the Restriction and Approval form, to the submitter via the clearance service provider computer system on the computer network. In another preferred embodiment, reviewers can enter their suggested edits or modifications directly into the content. For example, a reviewer can create a “red-lined” version of the spot that contains changes that would place the spot in condition for approval. This is possible given that the content is in digital form and is being viewed in the form of a computer file, such as a QuickTime file, by the reviewer. As such, the reviewer may have the appropriate software to make changes to the content directly. Once the feedback form is transmitted from the second computer system, the files from the electronic package originally received are deleted from memory. More specifically, the files are deleted from the second computer system cache. In the preferred embodiment, the Approval and Restriction form is transmitted back to the clearance service provider computer system the same way it was received, via secure FTP or any other appropriate transmission means having the required security level.

At step 222 the clearance service provider transmits the feedback form to the submitter. At this time copies of the encoded files, the submission form, and the feedback form, and any other data are removed from cache and stored in long-term memory for archiving. A policy regarding the archiving of encoded files can differ with various content sponsors and is arranged with the service provider. In this manner, the archiving of physical tapes and papers is avoided. Similarly, the destruction of such materials is avoided as well. Once the submitter receives the feedback form, the content sponsor can take appropriate action, such as modify the spots if necessary or, if approved, prepare high-grade resolution versions of the spots intended for broadcasting. The archiving of the spots at the clearance service facility allows the broadcaster to check that the high-grade version it receives for broadcasting from the content sponsor is the same as the version that the broadcaster had approved. In another preferred embodiment, the broadcaster itself can archive spots that it has approved for this final checking function. In addition, the clearance service facility can send a copy of the feedback form to the content creator, such as an advertising agency, if requested by the content sponsor. This can be done as a “cc” or as instructions to the content creator to proceed with preparing the high-grade broadcast version of the spot or spots, if such arrangements were made previously with the content sponsor. If the feedback form indicates that the spots were rejected, modifications are made to the spots and the process begins again with the encoding of the modified spots by the content sponsor. At this stage, one complete cycle of the network clearance process has been performed.

An industry related to the television industry is the movie industry. In the movie industry, the Motion Picture Association of America (“MPAA”), is required to check any content that appears on a theater screen. It is also required to check any printed material, such as promotional content, appearing in a movie theater. One example of the MPAA's checking function is clearing all spots appearing on the screen before a feature film is shown. For example, all movie trailers, advertisements, public announcements, trivia questions, short animations requesting that the audience be quiet during the show, must be cleared by the MPAA. In this preferred embodiment, the MPAA is the content checker performing the clearance function for the movie theater companies, i.e., the content disseminators.

As described above, the content checking system described can be in contexts other than television clearance. For example, in the criminal investigation field, an investigative body, such as the FBI, can use the content checking system to evaluate audio, visual, photographic, and other types of content. For example, content can come from wiretaps, such as recorded phone calls. This content may need to be checked by various parties, such as prosecutors to determine what portions of it can be used as evidence or by interpreters to determine which parts of the conversations are relevant. In any case, the content needs to be distributed to various parties and feedback from those parties needs to be gathered and sent back to the content sponsors, i.e., the FBI, DEA, and so on.

In another preferred embodiment, a content disseminator, such as a clearance department at a studio, receives a physical or tangible object, such as a CD-ROM. If the content that needs to be checked is voluminous, such as an entire feature length film, or of such a nature that it simply cannot be digitized and sent over a network, sending it electronically from the content sponsor to the content disseminator may be impractical, inefficient, or impossible. However, the present invention can still be used to check the content, for example, approve/restrict a movie. In a preferred embodiment, if the content can be digitized, it is encoded onto a physical medium such as a CD-ROM, a DVD, or a DV tape. The medium may contain a code which could be entered by the content checker to display or gain access to information pertaining to the content. In order to secure the encoded content on the physical medium, the content must be encrypted. Normally, using current encryption technology, a key to decrypt the content is held on a server at the content disseminator so that a person attempting to view the content on a computer not connected to the server or, generally, not authorized to view the content, would not be able to do so. In a preferred embodiment, the clearance service provider provides a key to a content checker wherein the key does not allow a viewer at the content checker to browse the content of the physical medium using the viewer's desktop, thereby allowing access to the entire content of the physical medium. The key provided permits access to the content of the physical medium only through the clearance service provider interface. Thus, in effect, the service provider can dictate whet can be viewed on the physical medium after the medium has been sent to the content disseminator. This is a useful feature if the content submitter changes the content on the physical medium or no longer wants the content checker to consider a particular content item on the physical medium.

Thus, in a preferred embodiment, the content checking system can encrypt the content before transmitting the content among the entities. For example, in the electronic package example described above in which there may be numerous encoded files for numerous spots, some of the files may be encrypted so that only certain recipients having a required key to “unlock” the file can view the content. This is useful if a package or any other type of collection of content items is being sent to multiple recipients and a particular recipient is only intended to

1. A method of checking content comprising:
placing content in electronic form thereby creating an electronic content file on a first computer system;
storing the electronic content file in a content medium on the first computer system;
completing a submission form, the submission form describing the content medium and indicating one or more recipients of the content medium, the submission form completed by a submitter;
transmitting the content medium and the submission form to the one or more recipients;
a recipient collecting feedback data on the electronic file content stored on the content medium; and
transmitting the feedback data to the submitter.

2. A method as recited in claim 1 further comprising assigning an identifier to the electronic content file and storing the identifier in the content medium and assigning an identifier to the electronic content file.

3. A method as recited in claim 2 further comprising storing additional electronic content files on the content medium.

4. A method as recited in claim 1 further comprising completing a submission form at a service provider computer system.

5. A method as recited in claim 4 wherein the submission form is available at a web site at the service provider computer system.

6. A method as recited in claim 1 further comprising transmitting the content medium and the submission form to the one or more recipients using a global computer network.

7. A method as recited in claim 1 wherein a recipient collecting feedback data on the electronic file content further comprises attaching an evaluation form to the electronic file content.

8. A method as recited in claim 1 wherein the feedback data is transmitted to the submitter via the service provider computer system.

9-31. (canceled)

32. A method of checking content comprising:
placing content in a physical form thereby creating a physical content package;
completing a submission form, the submission form describing the content package and indicating one or more recipients of the content package, the submission form completed by a submitter;
sending the content package and the submission form to the one or more recipients;
a recipient collecting feedback data on the content package; and
transmitting the feedback data to the submitter.

33. A method of checking content as recited in claim 32 wherein the physical content package is a CD-ROM or a DVD.

34. A method of checking content as recited in claim 32 wherein the physical content package contains content that is encrypted using a key provided by a content checking service provider.

35. A method of checking content as recited in claim 32 further comprising viewing the physical content package using a key such that a subset of the data is blocked.
